(19) United States
(12) Patent Application Publication
(10) Pub. No.: US 2026/0183918 A1
(43) Pub. Date: Jul. 2, 2026

(54) Chisel with a Long Service Life and Method for Producing Such a Chisel

(71) Applicant: Hilti Aktiengesellschaft, Schaan (LI)

(72) Inventors: Árpád HORVÁTH, Kecskemét (HU); Bertalan KECSKÉS, Helvécia (HU); Gabor RAKONCZAI, Fülöpháza (HU); Norbert TAJTHI, Kecskemét (HU)

(21) Appl. No.: 18/863,914

(22) PCT Filed: Apr. 27, 2023
(86) PCT No.: PCT/EP2023/061090

§ 371 Date: Nov. 7, 2024

(30) Foreign Application Priority Data
May 10, 2022 (EP) 22172528.6

(51) Int. Cl. B25D 17/02

(52) U.S. Cl. CPC B25D 17/02; B25D 2222/42; B25D 2222/51

(57) ABSTRACT

A chisel includes a working section, a shaft section, and a striking surface. A longitudinal axis runs through the working section, the shaft section, and the striking surface. In a cross section of the working section running transversely to the longitudinal axis, a first structural core region has a first core hardness which is substantially less than a first external hardness in a first external region outside of the first structural core region within the cross section of the working section.

### BACKGROUND AND SUMMARY OF THE INVENTION

The invention relates to a chisel which has a working section, a shaft section, a striking surface and a longitudinal axis running through the working section, the shaft section and the striking surface.

Such chisels are used on construction sites to chisel mineral stone, for example concrete. During use, the working section wears down, and therefore a theoretically maximum possible useful life, that is to say the maximum theoretical service life, is the product of cumulative use from first use to the last possible use, once the working section has been worn down to the maximum extent.

Particularly when such chisels are used intensively in heavily reinforced concrete, the chisels may break, and therefore their maximum, actual service life is considerably shortened in these cases.

It is therefore the object of the present invention to offer chisels of the type in question that have a low risk of breakage. Furthermore, a method for producing such chisels is desirable.

The object is achieved by a chisel which has a working section, a shaft section, a striking surface and a longitudinal axis running through the working section, the shaft section and the striking surface. In a cross section of the working section running transversely to the longitudinal axis, a first structural core region has a first core hardness, which is substantially less than a first external hardness in a first external region outside the first structural core region of the same cross section.

Thus, the chisel can have material of different hardnesses in the region of the working section. In particular, the chisel can be softer on the inside in the region of the working section than at its surface.

Conversely, it can be tougher in the interior, particularly in the first structural core region, than at the surface and/or in the first external region.

Tests by the applicant have shown that the risk of breaks is extremely low with such chisels.

In this context, a “substantial” difference between two values of a measured variable can be understood to mean a difference of at least 10%, in particular of at least 20%.

Accordingly, an insubstantial difference between the two values can be understood to mean a deviation of, for example, less than 10%, in particular less than 5%.

In the case, for example, of a non-rotationally symmetrical chisel, such as a channel chisel, a longitudinal plane of the chisel may also be regarded as the longitudinal axis.

The working section can have webs, projections and/or the like. These can be configured to reduce the risk of jamming in a substrate to be worked.

Particularly in the method, hardness data can be determined according to Vickers. Alternatively or additionally, hardness data can also be determined according to Rockwell, for example according to scale C.

In a cross section of the shaft section, a second structural core region can have a second core hardness.

The second core hardness can be substantially less than a second external hardness in a second external region outside the second core region of the same cross section.

In particular, the shaft section can thus have a core which is soft in relation to its surface.

The first core hardness can be substantially greater than the second core hardness, and therefore the working section is generally harder than the shaft section. The working section and thus the chisel can therefore furthermore have a long theoretically maximum possible service life.

The first core hardness can be substantially less than the second external hardness.

The first structural core region can comprise tempered martensite, in particular can consist of tempered martensite. The microstructure containing tempered martensite can be produced by at least two-fold heat treatment, in particular, inter alia, using at least one shock induction heat treatment.

The first external region can comprise martensite, in particular can consist of martensite. The microstructure can be produced by at least one induction heat treatment.

The cross section of the chisel comprising the first external region and the first structural core region can have a geometric core region which is defined by the largest-area ellipse inscribed in the cross section.

Chisels which are particularly resistant to breakage can then have an area ratio of the first structural core region to the geometric core region in the range from 40 to 80%.

Also within the scope of the invention is a method for producing a chisel having the features described above and/or below, wherein a chisel blank which has a working section, a shaft section and a striking surface and a longitudinal axis running through the working section, the shaft section and the striking surface is machined.

The chisel blank may not yet be heat-treated.

The method comprises an induction heat treatment of the working section, wherein both the first external region and the first core region are hardened, and an induction heat shock treatment of the working section, with the result that the first external region has a substantially greater hardness than the first core region.

Preferably, the induction heat treatment is carried out first and then the induction heat shock treatment.

The induction heat shock treatment can extend over the entire chisel, in particular over the working section and the shaft section.

Further features and advantages of the invention are apparent from the detailed description of exemplary embodiments of the invention that follows, with reference to the figures of the drawing which shows details essential to the invention, and from the claims. The features shown therein should not necessarily be considered to be true to scale and are illustrated in such a manner that the special features according to the invention can be clearly visualized. The various features can be implemented individually in their own right or collectively in any combinations in variants of the invention.

Exemplary embodiments of the invention are illustrated in the schematic drawings and elucidated in detail in the description that follows.

### BRIEF DESCRIPTION OF THE DRAWINGS

FIG. 1 shows a chisel,

FIG. 2 shows a hardening diagram of a chisel,

FIG. 3 shows a schematic longitudinal section through a chisel,

FIGS. 4a and 4b show schematic cross sections of different chisels with markings of geometric and structural core regions,

FIG. 5 shows a flowchart of a method, and

FIGS. 6a and 6b show diagrams of experimentally determined chisel service lives.

### DETAILED DESCRIPTION OF THE DRAWINGS

In the description of the figures that follows, comprehension of the invention is made easier by the use of the same reference signs in each case for identical or functionally corresponding elements.

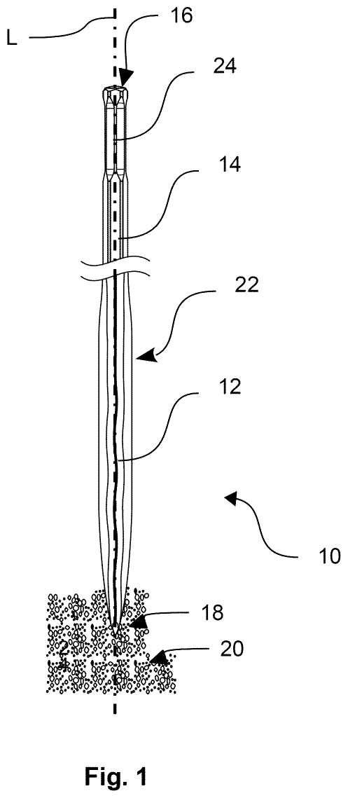

FIG. 1 shows a chisel 10. The chisel 10 is in the form of a pointed chisel. It has a working section 12, a shaft section 14 and a striking surface 16. At the free end of its working section 12, the chisel 10 has a tip 18.

A longitudinal axis L runs through the working section 12, the shaft section 14 and the striking surface 16.

The chisel 10 can be driven into a substrate 20 by blows on its striking surface 16, for example with the aid of a machine tool (not shown in FIG. 1) mounted in the region of the striking surface 16. In the example according to FIG. 1, the substrate 20 is a mineral substrate, e.g., reinforced concrete.

In the exemplary embodiment of the chisel 10 shown in FIG. 1, the working section 12 has a plurality of ribs 22. To simplify the illustration, only one of the ribs 22 is provided with a reference sign in FIG. 1. The ribs 22 can be configured to prevent jamming of the chisel in the substrate 20 or at least to reduce the risk of such jamming.

Over the life of the chisel 10, the working section 12 usually wears down, whereas the shaft section 14 does not or does so at most to an insignificant extent. The chisel 10 reaches its maximum end of use when the working section 12 has been completely shortened or at least shortened to a certain minimum, unless a breakage or similarly severe damage to the chisel 10 occurs before this.

A shank 24 is formed on the shaft section 14. In the exemplary embodiment shown in FIG. 1, the shank 24 can be designed as a hexagon and/or comprises such a hexagon. Alternatively, it is also conceivable that the shank 24 corresponds to some other standard, for example a standard usually referred to as “SDS Plus” or “SDS Max”.

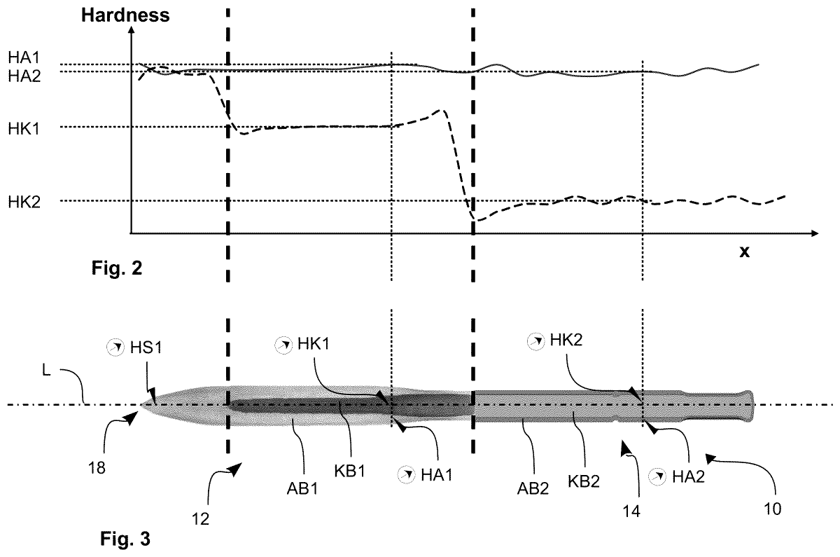

FIG. 2 shows a hardening diagram for local hardening of the chisel 10 along its longitudinal axis L. In the diagram, the abscissa corresponds to the respective position along the longitudinal axis L.

FIG. 2 shows respective profiles of hardnesses in external regions as well as in core regions corresponding to the respective position x or the respective cross section at the position x along the longitudinal axis L.

FIG. 3 shows a schematic longitudinal sectional view of the chisel 10 along the longitudinal axis L, making it possible to see to which sections the hardnesses according to FIG. 2 relate in each case.

FIG. 3 shows a first structural core region KB1, a first external region AB1, which surrounds the first structural core region KB1 radially, and a second structural core region KB2 with a second external region AB2 surrounding the latter radially.

In the region of its working section 12, in the first structural core region KB1, the hardness of the chisel 10 is a first core hardness HK1. The first core hardness HK1 is substantially less than a hardness in the first external region AB1, hereinafter referred to as the first external hardness HA1, outside the first structural core region KB1, within the same cross section of the working section 12. The first core hardness HK1 is between 50 and 80 percent, for example between 60 and 70 percent, of the first external hardness HA1. For example, the first core hardness HK1 can be in the range of 400 and 450 HV. The first external hardness HA1 can be in the range from 600 to 650 HV.

A second structural core region KB2, which is formed along the shaft section 14, has a hardness, hereinafter referred to as the second core hardness HK2, at least in one cross section. This is substantially less than a second external hardness HA2 in a second external region AB2 outside the second structural core region KB2 in the same cross section of the shaft section 14.

As can be seen in FIG. 2, the core hardness HK1 is substantially greater than the second core hardness HK2.

In the external regions AB1 and AB2, the hardnesses along the longitudinal axis L can be constant or at least substantially constant. In particular, the first external hardness HA1 and the second external hardness HA2 can be identical or at least substantially identical.

FIG. 2 further shows that the first core hardness HK1 is substantially less than the first external hardness HA1. It is also substantially less than the second external hardness HA2, particularly when the first and second external hardnesses HA1 and HA2 are identical or at least substantially identical.

FIG. 3 also shows that the microstructure of the first external region AB1 differs from that of the first structural core region KB1.

The first external region AB1 is formed from martensite. It can be fully hardened. In contrast, the first structural core region KB1 is formed from tempered martensite.

The tip 18 can likewise be formed from martensite. However, it is also conceivable, in particular after a certain wear of the chisel 10 and, in particular, of the tip 18, if the first structural core region KB1 extends into the tip 18, that the tip 18 alternatively or additionally comprises tempered martensite.

Other microstructures, in particular perlite and/or ferrite, can be present in the interior of the shaft section 14, in particular in the second structural core region KB2.

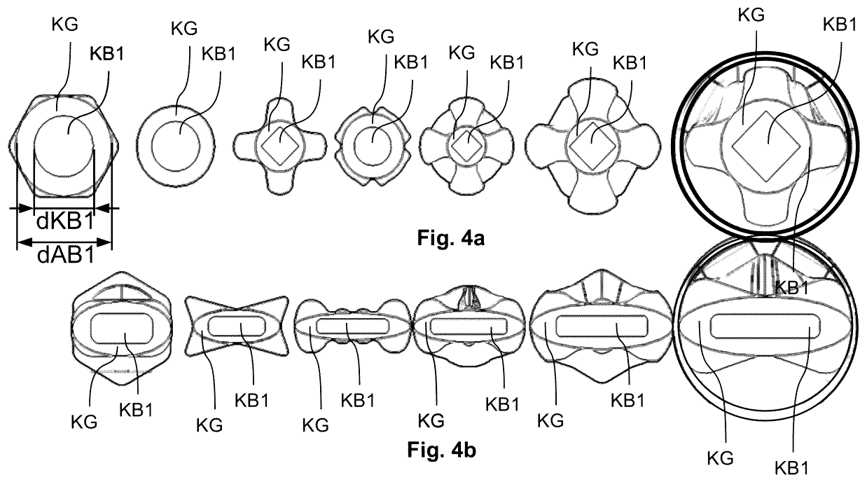

FIG. 4a and FIG. 4b show, by way of example, cross sections of different chisels 10. The cross sections each originate from respective working sections 12 (see FIG. 1). FIG. 4a shows cross sections of pointed chisels, whereas FIG. 4b shows cross sections of flat chisels.

In the individual example cross sections, the respective first core regions KB1 and associated geometric core regions KG are marked in each case. Here, the geometric core regions KG are defined as the largest-area ellipses inscribed in the respective cross section of the working section 12.

The area ratios of the respective first structural core regions KB1 to the respective geometric core regions KG associated therewith are in the range from 30 to 90 percent, in particular in the range from 40 to 80 percent. For example, the ratio of the diameter dKB1 of the first structural core region KB1, which is circular in cross section, to the diameter dAB1 of the associated external region AB1 in the case of the first pointed chisel from the left in FIG. 4a is approximately 63%, giving an area ratio of 0.4, that is to say corresponding to 4*10¹ percent.

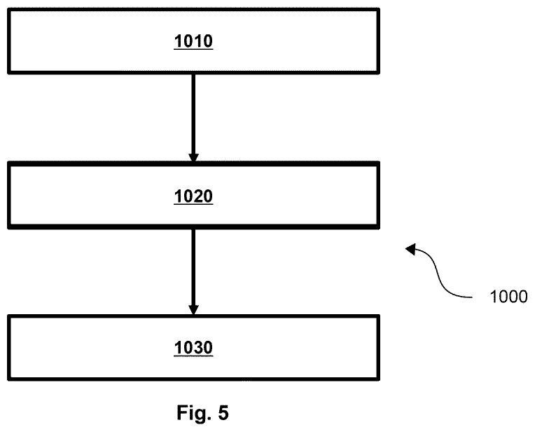

FIG. 5 shows a flowchart of a method 1000 for producing a chisel 10.

In a preparation phase 1010, a chisel blank is first produced, which has a working section 12, a shaft section 14 and a striking surface 16.

The chisel blank to be produced has an elongate shape, with the result that a longitudinal axis L runs through its working section 12, the shaft section 14 and the striking surface 16.

In a heating phase 1020, the working section 12 is heat-treated by means of induction heat. In this first heating operation, both the first external region AB1 and the first structural core region KB1 reach a homogeneous austenitization temperature. As a result of sufficiently rapid cooling, the full cross section of the working section 12 is hardened. In this case, therefore, both the first external region AB1 and the first structural core region KB1 are converted into martensite and correspondingly hardened.

In a subsequent shock heating phase 1030, the working section 12 is then shock heat-treated with the aid of an induction heat shock treatment. The first external region AB1 is thereby hardened further. This gives the first external region AB1 a substantially greater hardness than the first structural core region KB1. In the first structural core region KB1, on the other hand, the shock heat treatment results at most in a smaller temperature rise than in the first external region AB1. In particular, reaching of an austenitization temperature can be avoided, and therefore, at least substantially, no further allotropic conversion takes place. In the first structural core region KB1, a phase comprising α+Fe₃C can form.

The shaft section 14 can be heat-treated before the shock heat treatment.

The applicant has carried out comparative tests on the life of chisels 10, in particular chisels produced according to method 1000, in comparison with already known comparison chisels.

For this purpose, in a first series of tests with a commercially available chisel hammer with an impact energy in the range from 25 to 30 J per stroke, chisels to be tested were tested for up to six hours in strongly reinforced concrete, in particular with three-layer steel reinforcements with a diameter of 16 mm and a pitch of 150×150 mm, and concrete of class C25/30 GK32.

With a total of 10 comparison chisels, the failure rate was about 50% within the test period of at most six hours. On the other hand, of 40 chisels 10, there was not a single failure over the respective maximum duration of the tests of six hours.

As part of a second series of tests, rotational bending tests were carried out and the numbers of cycles that the respective tested chisel was able to withstand were recorded. Here, one cycle corresponds to one complete revolution.

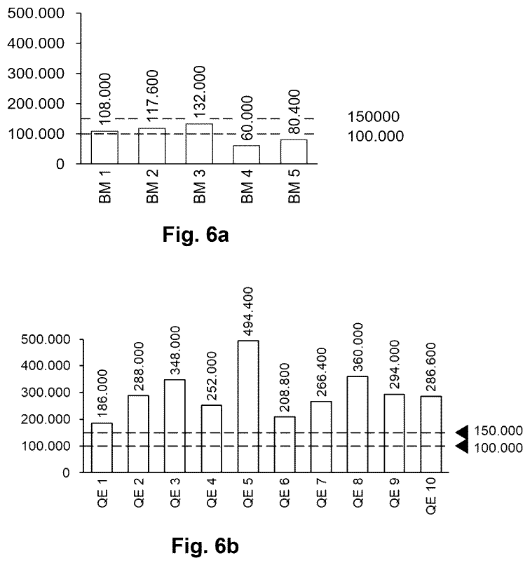

As can be seen from the diagram according to FIG. 6a, of the comparison chisels BM1, BM2, BM3, BM4 and BM5 only two chisels achieved a life of at least 100,000 cycles. None of the comparison chisels survived more than 150,000 cycles. Two of the five comparison chisels did not even reach 100,000 cycles.

On the other hand, all the tested chisels 10 survived 150,000 cycles, as shown in the diagram according to FIG. 6b. Some of the chisels 10 even reached lifetimes of just under 500,000 cycles.

Thus, the risk of breakage of the tested chisels 10 is considerably reduced as compared with the tested comparison chisels.

### LIST OF REFERENCE CHARACTERS

10 Chisel
12 Working section
14 Shaft section
16 Striking surface
18 Tip
20 Substrate
22 Rib
24 Shank
1000 Method
1010 Preparation phase
1020 Heating phase
1030 Shock heating phase
AB1 External region
AB2 External region
HA1 External hardness
HA2 External hardness
HK1 Core Hardness
HK2 Core Hardness
KB1 Structural core region
KB2 Structural core region
KB2 Structural core region
KG Geometric core region
L Longitudinal axis
dAB1 Diameter
dKB1 Diameter
x Position

1.-8. (canceled)

9. A chisel (10), comprising:
a working section (12);
a shaft section (14); and
a striking surface (16);
wherein a longitudinal axis (L) runs through the working section (12), the shaft section (14), and the striking surface (16);
wherein, in a cross section of the working section (12) running transversely to the longitudinal axis (L), a first structural core region (KB1) has a first core hardness (HK1) which is substantially less than a first external hardness (HA1) in a first external region (AB1) outside of the first structural core region (KB1) within the cross section of the working section (12).

10. The chisel (10) as claimed in claim 9, wherein, in a cross section of the shaft section (14), a second structural core region (KB2) has a second core hardness (HK2) which is substantially less than a second external hardness (HA2) in a second external region (AB2) outside of the second structural core region (KB2) within the cross section of the shaft section (14).

11. The chisel (10) as claimed in claim 10, wherein the first core hardness (HK1) is substantially greater than the second core hardness (HK2).

12. The chisel (10) as claimed in claim 10, wherein the first core hardness (HK1) is substantially less than the second external hardness (HA2).

13. The chisel (10) as claimed in claim 9, wherein the first structural core region (KB1) comprises tempered martensite.

14. The chisel (10) as claimed in claim 9, wherein the first external region (AB1) comprises martensite.

15. The chisel (10) as claimed in claim 9, wherein a cross section of the chisel (10) comprising the first external region (AB1) and the first structural core region (KB1) has a geometric core region (KG) which is defined by a largest-area ellipse inscribed in the cross section of the chisel (10) and wherein an area ratio of the first structural core region (KB1) to the geometric core region (KG) is in a range from 40% to 80%.

16. A method (1000) for producing the chisel (10) as claimed in claim 9, comprising the steps of:
machining a chisel blank which has the working section (12), the shaft section (14), and the striking surface (16);
induction heat treatment of the working section (12) wherein both the first external region (AB1) and the first structural core region (KB1) are hardened; and
induction heat shock treatment of the working section (12) such that the first external region (AB1) has a substantially greater hardness than the first structural core region (KB1).
